(19) United States
(12) Patent Application Publication
(10) Pub. No.: US 2026/0006318 A1
(43) Pub. Date: Jan. 1, 2026

(54) IMAGE CAPTURING APPARATUS, AND CONTROL METHOD THEREOF

(71) Applicant: CANON KABUSHIKI KAISHA, Tokyo (JP)

(72) Inventors: YUKI TSUJIMOTO, Tokyo (JP); HIROKI KITANOSAKO, Tokyo (JP)

(21) Appl. No.: 19/237,770

(22) Filed: Jun. 13, 2025

(30) Foreign Application Priority Data
Jun. 27, 2024 (JP) 2024-104353

(51) Int. Cl. H04N 23/65; H04N 23/667; H04N 25/531

(52) U.S. Cl. CPC H04N 23/651; H04N 23/667; H04N 25/531

(57) ABSTRACT

An image capturing apparatus includes an image sensor, and at least one processor or circuit that executes a program and performs operations of the following units: a readout unit that reads out image data from the image sensor, a processing unit that performs a processing for recording on image data read out by the readout unit, a memory that is accessed by the processing unit for processing of the image data, and a control unit that performs a control to restrict access of the processing unit to the memory during a readout period of image data by the readout unit in a shooting mode in which the readout unit reads out image data of a still image for recording from the image sensor and the processing unit performs the processing for the record.

### BACKGROUND

### Field of the Technology

The present disclosure relates to a power control technology in an image capturing apparatus.

### Description of the Related Art

There has been proposed an image capturing apparatus that enables shooting with reduced rolling distortion without using a mechanical shutter by mounting an image sensor that can simultaneously read out a plurality of pieces of pixel data. However, as more pieces of pixel data are read at a higher speed, the maximum current consumed by the image sensor increases.

Furthermore, in order to achieve higher pixels and higher image quality in the image capturing apparatus, an image processing engine is also required to be increased in speed. It has also been proposed to achieve high-speed image processing by a plurality of image processing engines. The maximum value (maximum current) of the current required in the image capturing apparatus increases due to an increase in processing speed in the image processing engine or a configuration of a plurality of image processing engines.

When the maximum current increases, the current supplied from a battery of the image capturing apparatus exceeds an allowable value, the voltage of the battery decreases, and there is a concern that a “system down” will occur. When the maximum current becomes large, a voltage drop due to the internal resistance of the battery or the wiring resistance becomes large, there is a concern that a “system down” will occur also due to the voltage falling below the minimum drive voltage of the image capturing apparatus.

On the other hand, in order to avoid a “system down”, it is conceivable to stop the operation before the voltage of the battery becomes equal to or less than a predetermined value. However, in that case, the capacity of the battery cannot be used up, and the operable time period of the image capturing apparatus is significantly reduced.

Japanese Patent Laid-Open No. 2024-22343 discloses an image capturing apparatus using a power storage device as a method of lowering the maximum current.

However, in the known technique disclosed in Japanese Patent Laid-Open No. 2024-22343, it is necessary to add a new component, and an influence of an increase in cost, an increase in size of a housing, and the like are conceivable.

### SUMMARY

The present disclosure has been made in view of the above-described problems, and provides an image capturing apparatus that can reduce the maximum current during operation while suppressing an increase in cost and an increase in size of the apparatus.

According to a first aspect of the present disclosure, there is provided an image capturing apparatus comprising: an image sensor; and at least one processor or circuit that executes a program and performs operations of the following units: a readout unit that reads out image data from the image sensor, a processing unit that performs a processing for recording on image data read out by the readout unit, a memory that is accessed by the processing unit for processing of the image data, and a control unit that performs a control to restrict access of the processing unit to the memory during a readout period of image data by the readout unit in a shooting mode in which the readout unit reads out image data of a still image for recording from the image sensor and the processing unit performs the processing for the record.

According to a second aspect of the present disclosure, there is provided a method for controlling an image capturing apparatus including an image sensor, a first processing circuit that receives image data read out from the image sensor, a second processing circuit that inputs image data output from the first processing circuit and performs processing for record, and a memory for the second processing circuit, the method comprising: restricting access to the memory in the processing during a readout period of image data by the readout in a shooting mode in which the first processing circuit reads out image data of a still image for record from the image sensor and the second processing circuit performs processing for the record.

According to a third aspect of the present disclosure, there is provided an image capturing apparatus comprising: an image sensor; a first integrated circuit (IC) chip; a first memory; a second IC chip; a second memory, wherein the first IC chip has a first controller that performs a control, in a shooting mode in which the first IC chip reads out image data of a still image for recording from the image sensor and the second IC chip performs a processing for recording on image data, to read out the image data of the still image for recording from the image sensor, store the image data in the first memory, read out the image data from the first memory, and send the image data read out from the first memory to the second IC chip, the second IC chip has a second controller that performs a control in the shooting mode to receive the image data from the first IC chip, perform the processing for recording on the image data received from the first IC chip with an access to the second memory, and record the processed image data on a recording medium, and wherein the first controller performs a control to restrict the access to the second memory for the processing for recording on the image data by the second IC chip during a readout period of image data by the first IC chip in the shooting mode.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capturing apparatus according to an embodiment of the present disclosure.

FIG. 2 is a view illustrating an example of a time chart in an electronic shutter mode of the image capturing apparatus.

FIGS. 3A and 3B are views illustrating a current taken out from a battery of the image capturing apparatus.

FIG. 4 is a flowchart showing an operation of a front control unit.

FIG. 5 is a view illustrating a determination example of a state of the battery by a battery determination unit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

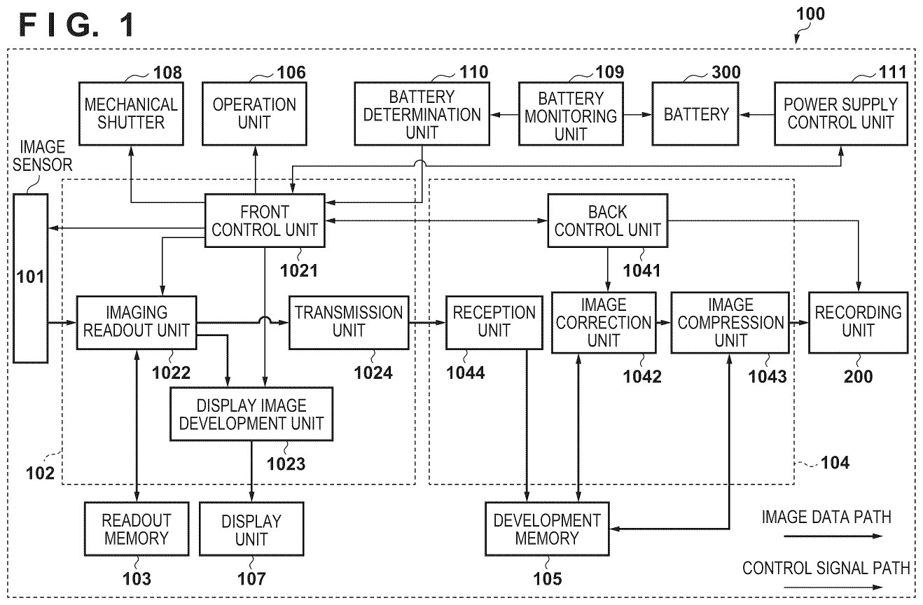

FIG. 1 is a block diagram illustrating a configuration of an image capturing apparatus 100 according to an embodiment of the present disclosure.

In FIG. 1, an image sensor 101 is a CMOS image sensor, and is configured by arranging a light-receiving element and an amplifier that amplifies an electric signal for each pixel. In the present embodiment, the image sensor 101 is configured as a stacked image sensor, a wiring layer for reading out pixel information is arranged on a back surface of the pixel, and the readout time can be shortened. In the present embodiment, an image sensor of a rolling shutter type is used, but an image sensor of a global shutter type that can simultaneously read out all pixels may be used.

The image sensor 101 receives light from a subject by each pixel and performs photoelectric conversion, and converts image data of each pixel obtained by the photoelectric conversion into digital data by an A/D converter in the image sensor 101. A front engine 102 is an image processing circuit configured as one semiconductor integrated circuit chip (IC chip). The front engine 102 includes at least one CPU and at least one circuit. The front engine 102 is an image processor that reads out image data and other data from the image sensor 101, performs necessary processing, and outputs processed data to a back engine 104. The front engine 102 is configured to include a front control unit 1021, an imaging readout unit 1022, a display image development unit 1023, and a transmission unit 1024.

The front control unit 1021 controls the operation of the image sensor 101 and the operations of a display unit 107 described later, a mechanical shutter 108, a power supply control unit 111, and the like.

The imaging readout unit 1022 reads out, from the image sensor 101, image data (image signal) obtained from each pixel of the image sensor 101, and writes the image data into a readout memory 103. The imaging readout unit 1022 reads out, from the readout memory 103, image data displayed as a live view, and sends the image data to the display image development unit 1023. As described later, at the time of shooting a moving image or a still image, the imaging readout unit 1022 reads out image data stored in the readout memory 103, and sends the image data to the back engine 104 via the transmission unit 1024. The readout memory 103 is a part of a work memory, is configured by a synchronous dynamic random access memory (SDRAM) or the like, and is used as a buffer memory.

In a case of a shooting standby state where a through image (live view image) is displayed, the display image development unit 1023 performs thinning processing and image correction processing for display on the image data read out from the readout memory 103. The image data converted into display data by the display image development unit 1023 is displayed on the display unit 107 described later. The transmission unit 1024 transmits, to the back engine 104, the image data sent from the imaging readout unit 1022.

The back engine 104 is an image processing circuit configured as one semiconductor integrated circuit (IC) chip. The back engine 104 includes at least one CPU and at least one circuit. The back engine 104 receives the image data output from the front engine 102, performs necessary processing, and then outputs the image data to a recording unit 200. The back engine 104 is an image processor that performs processing for recording, such as noise removal processing, compression processing, and recording format conversion processing, on image data read out from the image sensor 101 and output via the front engine 102, and is configured to include a back control unit 1041, an image correction unit 1042, an image compression unit 1043, and a reception unit 1044. The back control unit 1041 performs communication with the front control unit 1021 and control of the recording unit 200 described later and the like.

The image data sent from the front engine 102 is received by the reception unit 1044 and temporarily stored in a development memory 105. The image correction unit 1042 performs noise removal processing and correction processing on the image data output from the front engine 102 and stored in the development memory 105, and stores the image data subjected to the correction processing into the development memory 105. The image compression unit 1043 reads out, from the development memory 105, the image data corrected by the image correction unit 1042 and performs compression processing. JPEG compression processing is performed at the time of still image recording, and H.264 compression processing is performed at the time of moving image recording. The image correction unit 1042 and the image compression unit 1043 temporarily store data into the development memory 105 when performing processing. The development memory 105 is a part of a work memory, is configured by a synchronous dynamic random access memory (SDRAM) or the like, and is used as a buffer memory.

An operation unit 106 is used to receive an instruction from the user, and sends a signal to the front control unit 1021. The operation unit 106 includes, for example, operation members such as a power supply button for the user to instruct on/off of power supply of the image capturing apparatus 100, a release switch for instructing shooting, and a zoom lever for instructing a zoom operation. The operation unit 106 also includes a reproduction button for instructing reproduction of image data, a mode dial for instructing a start-up mode of the image capturing apparatus 100, and a touch panel disposed on the display unit 107 described later.

Here, the release switch includes a switch SW1 and a switch SW2. When the release switch is in a so-called half-pressed state, the switch SW1 is turned on. By this, the front control unit 1021 receives an instruction for shooting preparation, such as autofocus (AF) processing, automatic exposure (AE) processing, automatic white balance (AWB) processing, and electronic flash (EF) processing. When the release switch is in a so-called fully-pressed state, the switch SW2 is turned on. By this, the front control unit 1021 receives an instruction for performing shooting. While the switch SW2 is turned on, the front control unit 1021 is brought into a state of continuous shooting operation in which shooting of still images is continuously executed.

The display unit 107 performs display of a live view image at the time of shooting, display of shot image data, character display for interactive operation, and the like. Here, the display unit 107 is not necessarily incorporated in the image capturing apparatus 100. The image capturing apparatus 100 may be connected to the display unit 107 that is outside, and may have a display control function of controlling display of the display unit 107.

The mechanical shutter 108 controls light entering the image sensor 101. In the electronic shutter mode, the mechanical shutter 108 is left open. Only at the time of the mechanical shutter mode, the mechanical shutter 108 operates under the control of the front control unit 1021, and controls exposure time.

The image data compressed by the image compression unit 1043 is output to the recording unit 200. The recording unit 200 records, into a recording medium, image data of a still image or a moving image output from the image compression unit 1043.

The recording unit 200 records image data into a removable external medium such as an SD card, a CF card, or an external SSD device, but may be configured to record image data in an internal memory.

A battery 300 corresponds to a power supply source of the image capturing apparatus 100, and is a removable lithium ion battery, for example. A DC coupler can be inserted into a mount portion of the battery 300 in place of the lithium ion battery. The DC coupler is a power supply adapter that supplies a necessary voltage from a commercial power supply to the image capturing apparatus 100 via an AC/DC conversion adapter.

A battery monitoring unit 109 monitors a voltage, a remaining capacity, a discharge current, and a temperature state of the battery 300, and transmits information to the front control unit 1021. The battery monitoring unit 109 can also calculate the internal resistance of the battery 300 from the discharge current and a voltage drop amount of the battery 300. It is also possible to calculate a resistance value including contact and wiring when the battery 300 is inserted into the mount portion of the battery 300 via an extension grip or the like.

A battery determination unit 110 determines, from the information obtained by the battery monitoring unit 109, whether or not the state of the battery 300 is a state where there is a problem when the maximum current flows from the battery 300 to the image capturing apparatus 100. The power supply control unit 111 performs control for supplying power from the battery 300 to each unit of the image capturing apparatus 100. The power supply control unit 111 includes a CPU, and controls power supply in response to an instruction from the front control unit 1021 as described later.

Typical operation modes of the image capturing apparatus 100 include a still image mode (still image shooting mode) and a moving image mode (moving image shooting mode). More specifically, the still image mode includes a single shooting mode for performing shooting one still image every time the release switch is pressed once, and a continuous shooting mode for continuously acquiring still images while the release switch is being pressed. The continuous shooting mode includes a high-speed continuous shooting mode in which the number of shot images per unit time is larger and a low-speed continuous shooting mode in which the number of shot images per unit time is relatively small.

The image capturing apparatus 100 has a plurality of operation modes. The plurality of moving image modes include an 8K recording mode for recording a moving image in which one screen has the number of pixels of 8K, a 4K recording mode for recording a moving image in which one screen has the number of pixels of 4K, and a full HD recording mode for recording a moving image in which one screen has the number of pixels of full HD. The user can also set the frame rate of the moving image to be recorded with the image capturing apparatus 100. The operation mode of the image capturing apparatus 100 may be changed in response to the user's operation, or may be automatically changed to an operation mode optimal for the user by the front control unit 1021 and the back control unit 1041.

When the user presses the release switch in the operation unit 106 and issues a shooting instruction for a still image, drive control for shooting a still image for recording (shooting for recording) is performed on the image sensor 101 by the instruction from the front control unit 1021, and image data of the still image for recording is read out from the image sensor 101. The image data is written into the readout memory 103, subjected to partial image processing and thinning processing, and transmitted to a development processing CPU 104. The transmitted image data is subjected to image correction by the image correction unit 1042 achieved by the CPU 104 for development, compressed into JPEG or the like by the image compression unit 1043, and recorded in the recording unit 200.

When the user presses a moving image recording button in the operation unit 106, drive control for shooting a moving image for recording is performed on the image sensor 101 by an instruction from the front control unit 1021, and moving image data for recording of a plurality of frames is continuously read out from the image sensor 101.

The imaging readout unit 1022 temporarily stores, into the readout memory 103, the image data of the moving image for recording read out from the image sensor 101, then reads out the image data from the readout memory 103, and sends the image data to the back engine 104 via the transmission unit 1024. The image data sent to the back engine 104 is written in the development memory 105 by the reception unit 1044, then read out to and corrected by the image correction unit 1042, further subjected to compression processing by the image compression unit 1043, and recorded as a moving image into the recording unit 200.

In FIG. 1, a thick line is an image data path, and a thin line is a control signal path. Through the image data path, it is necessary to send image data of high pixels at high speed in order to perform high-speed still image continuous shooting and recording at a high frame rate. In particular, in a case of handling large-capacity data at a higher speed such as a still image high-speed continuous shooting mode, the image sensor 101, the front engine 102, and the back engine 104 need to process the data within a limited time in accordance with the continuous shooting speed in the high-speed continuous shooting mode. Therefore, the image capturing apparatus 100 consumes a large amount of power instantaneously. As a result, the maximum value of the current flowing from the battery 300 (hereinafter, maximum current) increases.

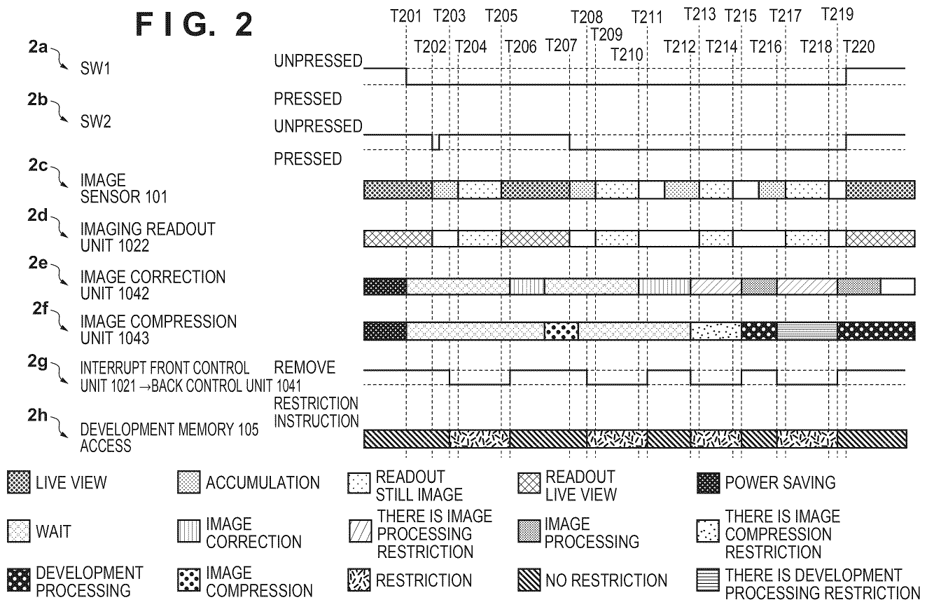

Hereinafter, an example of an operation time chart in the still image mode of the image capturing apparatus 100 in the present embodiment will be described with reference to FIG. 2. FIG. 2 illustrates processing in a case where the power supply of the image capturing apparatus 100 is turned on and a shooting instruction for a still image is issued in a state where a live view image is displayed on the display unit 107 in the shooting standby state. In the shooting standby state, the front control unit 1021 controls the power supply control unit 111 to restrict power supply to the back engine 104. In this state, the back control unit 1041 can communicate with the front control unit 1021, but the image correction unit 1042 and the image compression unit 1043 cannot perform normal processing for recording of a still image. Therefore, the power consumption of the back engine 104 is in a reduced state. Then, as described later, when the switch SW1 is operated, the power supply control unit 111 is controlled to stop the restriction of the power supply to the back engine 104. In the following description, a “power saving state” indicates a state where power supply to the back engine 104 is restricted as described above. A “standby state” indicates a state where the restriction on the power supply to the back engine 104 is stopped and each unit of the back engine 104 is operable but the processing for recording of a still image is not executed. In FIG. 2, the horizontal axis represents time, and the vertical axis will be described sequentially from the top as follows. 2a illustrates the operation of the switch SW1 in the operation unit 106.

2b illustrates the operation of the switch SW2 in the operation unit 106. The release switch is a two-stage switch, and when the user presses the second-stage switch SW2, single shooting is performed. When the switch SW2 is kept pressed, continuous shooting is performed.

2c illustrates a drive mode of the image sensor 101. There are a state of live view operation and a state of accumulation and readout operation of a still image.

2d illustrates a drive mode of the imaging readout unit 1022. There are a readout state of live view operation of reading out image data for live view from the image sensor 101 and a readout state of a still image of reading out image data for recording from the image sensor 101.

2e illustrates an operation state of the image correction unit 1042. There are an image correction execution state and a standby state.

2f illustrates an operation state of the image compression unit 1043. There are an image compression execution state and a standby state.

Each processing load of the processing of the imaging readout unit 1022, the image correction unit 1042, and the image compression unit 1043 varies depending on the operation, setting, and data amount. Therefore, although the processing is performed in time series in each process, the timing at which the processing ends varies. The readout memory 103 needs to hold image data until the image data can be transferred to the development memory 105. The development memory 105 needs to hold image data subjected to correction processing by the image correction unit 1042 and compressed next by the image compression unit 1043, and needs to hold image data compressed by the image compression unit 1043 and recorded next by the recording unit 200. Therefore, in a continuous shooting state of still images, processing of continuous shooting of a series of still images is performed, and unless still image data is sequentially recorded by the recording unit 200, there is no free space in the readout memory 103 and the development memory 105, and the next image data cannot be read out from the image sensor 101. When the image data for recording cannot be read out from the image sensor 101, continuous shooting of still images cannot be continued. As a result, the time during which continuous shooting can be continued is shortened.

2g illustrates interrupt control of requesting access restriction of the development memory 105 from the front control unit 1021 to the back control unit 1041.

Communication of interrupt control of requesting access restriction of the development memory 105 can also be included in a series of communication (SPI, I2C, PCIE, and the like) between the front control unit 1021 and the back control unit 1041. Here, in order to promptly notify the back engine 104 when interrupt processing is necessary, an interrupt notification is issued with a dedicated signal for interrupt that requests access restriction of the development memory 105. This is for controlling the time for giving access restriction to the development memory 105 described later to be short, and can prevent the continuation time of continuous shooting from being shortened.

2h illustrates a state where the back control unit 1041 restricts access of the image correction unit 1042 and the image compression unit 1043 to the development memory 105 during the readout period of image data from the image sensor 101 by the front engine 102.

In FIG. 2, the back control unit 1041 restricts the access of the image correction unit 1042 and the image compression unit 1043 to the development memory 105 in accordance with a control instruction of the interrupt control in (G). When the maximum value of the current in a still image readout period of the imaging readout unit 1022 does not increase, only one of the image correction unit 1042 and the image compression unit 1043 may be restricted from accessing to the development memory 105. Access to the recording unit 200 may be restricted.

When access to the development memory 105 is restricted, the access may be completely stopped, or the speed may be restricted by a method of reducing the number of data lanes or the communication rate. However, in a case where the development memory 105 also shares data unrelated to an image path such as program control, access to the development memory 105 regarding data other than the image path is not restricted.

Next, the operation at each timing will be described.

When the user presses the switch SW1, the image correction unit 1042 and the image compression unit 1043 transition from the power saving state to the standby state (T201).

When the user presses the switch SW2, the image sensor 101 performs light accumulation (T202).

The front control unit 1021 issues an interrupt notification to the back control unit 1041 in preparation for a readout operation from the image sensor 101 to the front engine 102. The back control unit 1041 restricts access of the image correction unit 1042 and the image compression unit 1043 to the development memory 105. At this time, since the image correction unit 1042 and the image compression unit 1043 have not yet operated, the operation of the image capturing apparatus 100 is not affected (T203).

The accumulation ends, and readout of a signal from the image sensor 101 to the imaging readout unit 1022 is started (T204). Power consumption of the image sensor 101 and the front engine 102 is maximized in a period until readout of image data of one screen ends (T205). The readout period varies depending on the mode. The shorter the readout period for the data amount of the image data to be read out, the more the power consumed instantaneously in the image sensor 101 and the front engine 102 increases. This readout period in the present embodiment is about 5 ms at the time of a still image electronic shutter.

Upon completing the readout of the image data of the still image of one screen by the imaging readout unit 1022 and upon completing the storage of the image data of one screen into the development memory 105, the front control unit 1021 removes the interrupt request to the back control unit 1041. The back control unit 1041 stops the access restriction of the image correction unit 1042 and the image compression unit 1043 to the development memory 105 (T206). Then, the imaging readout unit 1022 starts readout of image data of the still image from the development memory 105, and sequentially sends the read out image data to the image correction unit 1042 of the back engine 104.

Access restriction to the development memory 105 is performed, whereby the operation of the back engine 104 is temporarily delayed, and unprocessed image data is accumulated in the development memory 105. As a result, the continuation time of continuous shooting in the continuous shooting mode is shortened. Therefore, the restriction period of T203 to T206 is desirably as short as possible, such as suppressing T203 to T204 and T205 to T206 within 0.5 ms while reliably securing a readout section (T204 to T205). Here, time intervals of T203 to T204 and T205 to T206 are determined based on transition time from falling and rising timings of an interrupt signal of the front control unit 1021 to start and stop of access restriction of the development memory 105. Based on an operation timing of SW2, the front control unit 1021 determines an accumulation time of the image sensor 101 and a readout start timing T204 of still image data for recording in the image sensor 101. Then, the front control unit 1021 notifies the back engine 1041 of an interrupt for access restriction at T203, which is a timing before the readout start timing T204 of the image sensor by a time based on the transition time from when the back control unit 1041 receives the interrupt notification to when the access restriction of the development memory 105 is started.

Thereafter, the image data read out by the front engine 102 and sent to the back engine 104 is subjected to image correction processing by the image correction unit 1042, compressed by the image compression unit 1043, and saved in the recording unit 200. The above is the processing of the single shooting mode of the still image by a single shooting instruction of SW2.

It is assumed that the user presses the switch SW2 again (T207). Here, a case where the user continues to press the switch SW2 and the continuous shooting mode is executed will be described.

The front control unit 1021 issues an interrupt notification to the back control unit 1041 in preparation for a readout operation from the image sensor 101 to the front engine 102. The back control unit 1041 restricts access of the image correction unit 1042 and the image compression unit 1043 to the development memory 105. Also at this time, since the image correction unit 1042 and the image compression unit 1043 have not yet operated, the operation of the image capturing apparatus 100 is not affected (T208).

The accumulation ends, and readout is started from the image sensor 101 to the imaging readout unit 1022 (T209). Power consumption of the image sensor 101 and the front engine 102 is maximized in a period until readout ends (T210).

The imaging readout unit 1022 notifies the front control unit 1021 that the reading ends (T210). The front control unit 1021 removes the interrupt request to the back control unit 1041. The back control unit 1041 stops the access restriction of the image correction unit 1042 and the image compression unit 1043 to the development memory 105 (T211).

Thereafter, the data read out by the front engine 102 and sent to the back engine 104 is subjected to image correction processing by the image correction unit 1042, compressed by the image compression unit 1043, and saved in the recording unit 200.

Accumulation of the next shooting starts, and the front control unit 1021 issues an interrupt notification to the back control unit 1041 in preparation for a readout operation from the image sensor 101 to the front engine 102. The back control unit 1041 restricts access of the image correction unit 1042 and the image compression unit 1043 to the development memory 105 (T212).

The accumulation ends, and readout of image data from the image sensor 101 to the imaging readout unit 1022 is started (T213).

At this time, since the image correction unit 1042 and the image compression unit 1043 have performed the processing of the previous frame, power consumption of the back engine 104 increases. However, since the access restriction is given to the development memory 105, the processing of the image correction unit 1042 and the image compression unit 1043 is temporarily delayed, but the power of the back engine 104 can be reduced. Meanwhile, the image data held in the readout memory 103 cannot be transferred to the back engine 104, and the processing of the image data held in the readout memory 103 is delayed. However, in a case where the readout speed of the image sensor 101 is high and the time from T212 to T215 is sufficiently short, the influence of the delay in data processing is small. For example, in the case of continuous shooting of 40 frames per second, the processing of the image correction unit 1042 and the image compression unit 1043 are delayed for 5 ms (readout time described above) of (1 second÷40=) 25 ms.

When the readout of the imaging readout unit 1022 ends, the imaging readout unit 1022 notifies the front control unit 1021 that the reading ends (T214). The front control unit 1021 removes the interrupt request to the back control unit 1041. The back control unit 1041 stops the access restriction of the image correction unit 1042 and the image compression unit 1043 to the development memory 105 (T215).

When the access restriction to the development memory 105 is stopped, the operations of the image correction unit 1042 and the image compression unit 1043 resume.

Furthermore, accumulation of the next shooting starts, and the front control unit 1021 issues an interrupt notification to the back control unit 1041 in preparation for a readout operation from the image sensor 101 to the front engine 102. The back control unit 1041 restricts access of the image correction unit 1042 and the image compression unit 1043 to the development memory 105 (T216).

The accumulation ends, and readout of image data from the image sensor 101 to the imaging readout unit 1022 is started (T217).

Thereafter, the imaging readout unit 1022 notifies the front control unit 1021 that the reading ends (T218). The front control unit 1021 removes the interrupt request to the back control unit 1041. The back control unit 1041 stops the access restriction of the image correction unit 1042 and the image compression unit 1043 to the development memory 105 (T219). When the access restriction to the development memory 105 is stopped, the operations of the image correction unit 1042 and the image compression unit 1043 resume.

Thereafter, when the user releases the switch SW2 and the switch SW1 (T220), a continuous shooting sequence ends, and the image compression unit 1043 continues processing until the processing of the final image data in the continuous shooting ends and the recording is completed. Thereafter, the front control unit 1021 controls the power supply control unit 111 to restrict power supply to the back engine 104, and is brought into the shooting standby state.

In the present embodiment, the sequence in the case of the electronic shutter mode has been described, but in the case of the mechanical shutter mode (during operation of the mechanical shutter), drive power of the mechanical shutter 108 also increases. Therefore, when the power of the image sensor 101, the front engine 102, and the back engine 104 overlap, the current supplied from the battery 300 increases.

Also in the mechanical shutter mode, the front control unit 1021 may notify the back control unit 1041 of interrupt in accordance with a mechanical shutter driving timing. As a result, also at the time of operation of the mechanical shutter 108, the current supplied from the battery 300 can be reduced.

In the present embodiment, interrupt from the front control unit 1021 to the back control unit 1041 is performed only in the still image mode in which the current instantaneously flowing from the battery 300 is large. However, also in the moving image mode, when the processing of the image correction unit 1042 and the image compression unit 1043 are in time, access control to the development memory 105 may be similarly performed. As a result, also at the time of the moving image mode operation, the current supplied from the battery 300 can be reduced.

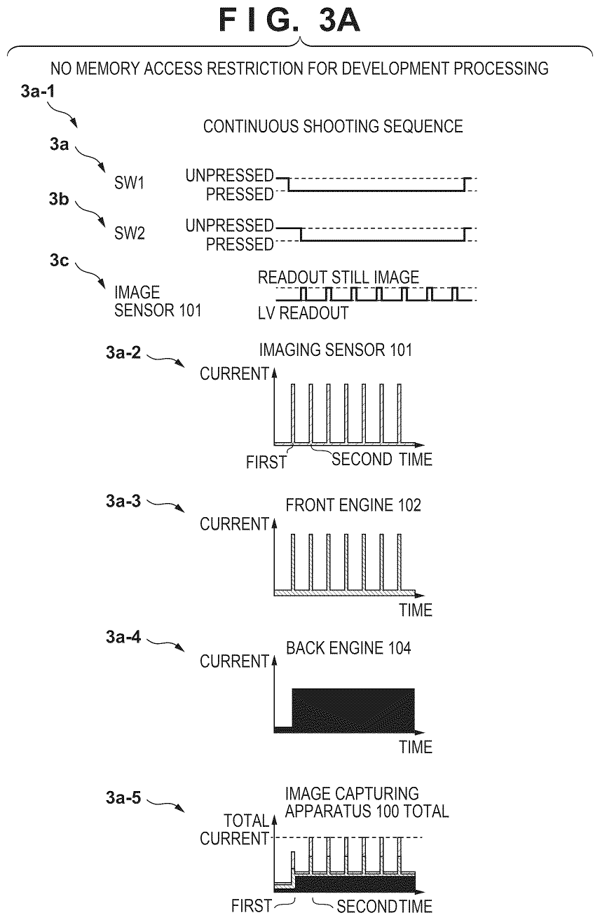

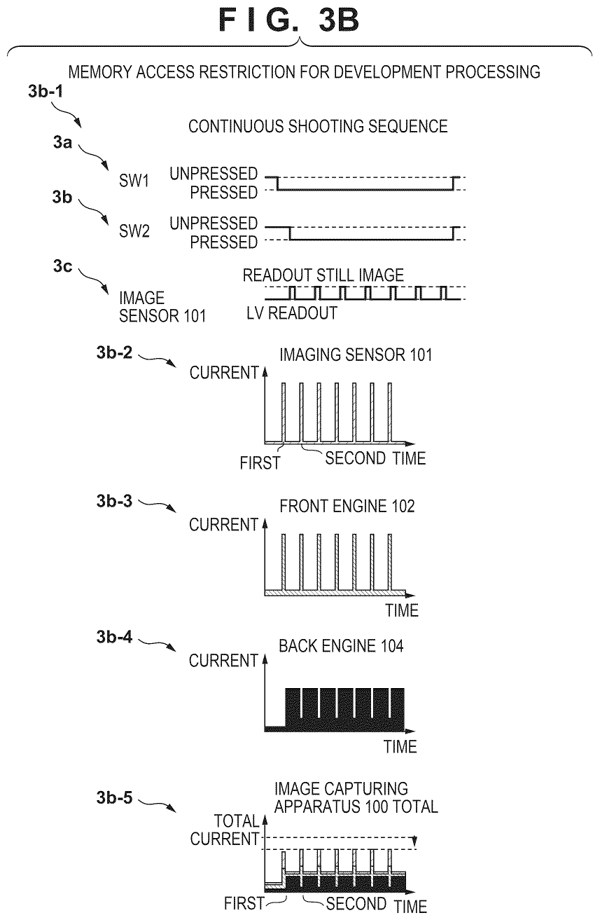

Hereinafter, the amount of current supplied from the battery 300 of the image capturing apparatus 100 in the present embodiment will be described with reference to FIGS. 3A and 3B.

FIG. 3A illustrates a case of not restricting access of the image correction unit 1042 and the image compression unit 1043 to the development memory 105. The horizontal axes of 3a-1, 3a-2, 3a-3, 3a-4, and 3a-5 of FIG. 3A indicate time, and the time axes are all common.

3a-1 of FIG. 3A is a view illustrating a continuous shooting sequence in the image capturing apparatus 100. The vertical axes will be sequentially described from the top as follows.

3a indicates operation of the switch SW1 in the operation unit 106.

3b indicates operation of the switch SW2 in the operation unit 106. The release switch is a two-stage switch, and when it is kept pressed in the continuous shooting mode, continuous shooting is executed.

3c indicates a timing of readout of a still image by the image sensor 101. While the switch SW2 is continuously pressed, readout is performed in a predetermined still image readout cycle.

The vertical axis of 3a-2 of FIG. 3A indicates the amount of current flowing through the image sensor 101 at the time of continuous shooting. In 3a-2 of FIG. 3A, a large current is consumed in accordance with a timing 3c for reading out image data from each pixel in the image sensor 101.

The vertical axis of 3a-3 of FIG. 3A indicates the amount of current flowing through the front engine 102 at the time of continuous shooting. Since the imaging readout unit 1022 reads out the image data from the image sensor 101 at the same timing as reading out the image data from each pixel in the image sensor 101, a large current is consumed in accordance with the readout.

The vertical axis of 3a-4 of FIG. 3A indicates the current amount at the back engine 104 at the time of continuous shooting. The current is continuously consumed from the end of the first readout.

The vertical axis of 3a-5 of FIG. 3A indicates a value in which the current amounts of 3a-2 of FIG. 3A, 3a-3 of FIG. 3A, and 3a-4 of FIG. 3A are added together.

From the second and subsequent frames, each consumption current overlaps, and the amount of current flowing from the battery 300 is maximized.

On the other hand, FIG. 3B illustrates a case of restricting access of the image correction unit 1042 and the image compression unit 1043 to the development memory 105. The horizontal axes of 3b-1, 3b-2, 3b-3, 3b-4, and 3b-5 of FIG. 3B indicate time, and the time axes are all common.

3b-1 of FIG. 3B is a view illustrating a continuous shooting sequence in the image capturing apparatus 100 of the present embodiment. The vertical axes will be sequentially described from the top as follows.

3a indicates operation of the switch SW1 in the operation unit 106.

3b indicates operation of the switch SW2 in the operation unit 106. The release switch is a two-stage switch, and when it is kept pressed in the continuous shooting mode, continuous shooting is executed.

3c indicates a timing of readout of a still image by the image sensor 101. While the switch SW2 is continuously pressed, readout is performed in a predetermined still image readout cycle.

3b-1 of FIG. 3B is assumed to be a continuous shooting sequence similar to 3a-1 of FIG. 3A.

The vertical axis of 3b-2 of FIG. 3B indicates the amount of current flowing through the image sensor 101 at the time of continuous shooting. In 3b-2 of FIG. 3B, a large current is consumed at a timing for reading out image data from each pixel in the image sensor 101. The image sensor 101 consumes a current similar to that in 3a-2 of FIG. 3A.

The vertical axis of b-3 of FIG. 3B indicates the amount of current flowing through the front engine 102 at the time of continuous shooting. Since the imaging readout unit 1022 reads out the image data from the image sensor 101 at the same timing as reading out the image data from each pixel in the image sensor 101, a large current is consumed in accordance with the readout. The front engine 102 also consumes a current similar to that in 3a-3 of FIG. 3A.

The vertical axis of 3b-4 of FIG. 3B indicates the current amount at the back engine 104 at the time of continuous shooting. The current is continuously consumed from the timing when the readout of the first image data by the imaging readout unit 1022 ends and the first image data is sent from the front engine 102. However, since the access of the image correction unit 1042 and the image compression unit 1043 to the development memory 105 is restricted at the readout timing 3c of the image data for recording in the image sensor 101 indicated by 3b-1 of FIG. 3B, the current consumption is temporarily lowered.

The vertical axis of 3b-5 of FIG. 3B indicates a value in which the current amounts of 3b-2 of FIG. 3B, 3b-3 of FIG. 3B, and 3b-4 of FIG. 3B are added together. From the second and subsequent frames, each consumption current overlaps, and the amount of current supplied from the battery 300 is maximized, but the maximum current is suppressed to be smaller than that in 3a-5 of FIG. 3A. For example, the current has a reduction effect of about 500 mA in a two-cell battery.

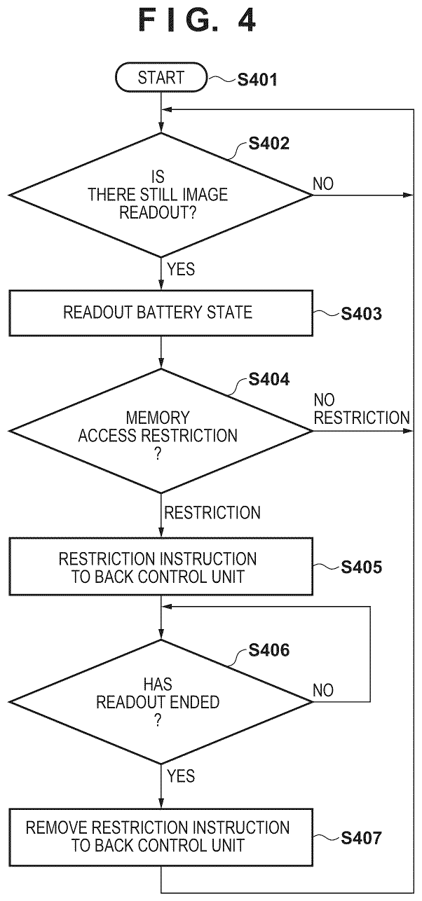

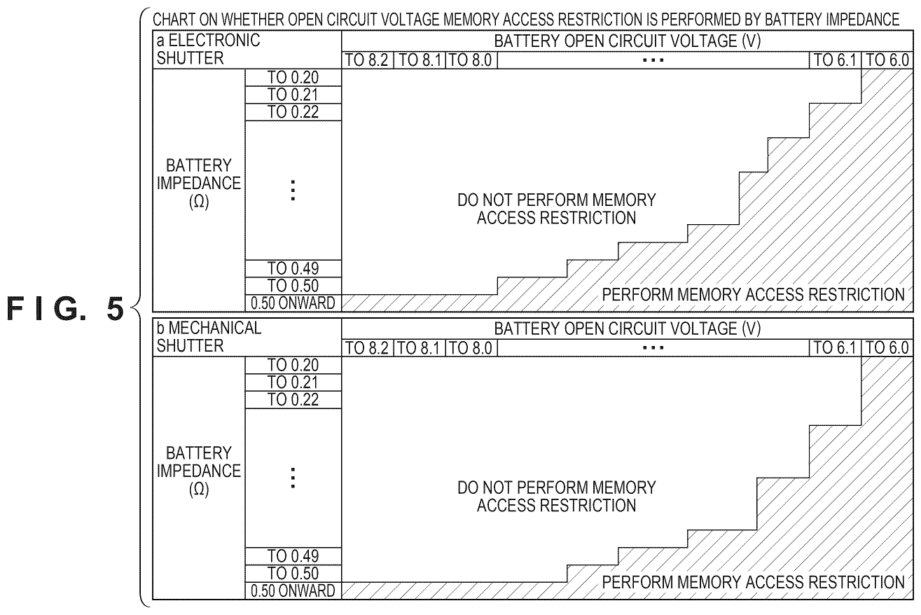

Hereinafter, the operation of the front control unit 1021 in the present embodiment will be described with reference to FIGS. 4 and 5.

When the image capturing apparatus 100 is started up, the operation of the front control unit 1021 is started in step S401 (hereinafter, “step” is omitted). As mentioned above, when the image capturing apparatus 100 is turned on, the front control unit 1021 performs control such that the image capturing apparatus 100 is brought into the shooting standby state and a live view image is displayed on the display unit 107.

In S402, the front control unit 1021 waits until the user operates the switch SW2 and an instruction for still image shooting is given.

When the still image shooting is instructed, the battery determination unit 110 receives battery information of the battery 300 from the battery monitoring unit 109 in S403. The information to be received includes the type of the battery 300, the voltage of the battery 300, the current drawn from the battery 300, and resistance information derived from a voltage change.

In S404, based on the battery determination information from the battery determination unit 110, the front control unit 1021 determines whether or not to perform interrupt notification to the back control unit 1041, that is, whether or not to restrict access of the image correction unit 1042 and the image compression unit 1043 to the development memory 105.

As described with reference to FIG. 2, the back control unit 1041 restricts the access of the image correction unit 1042 and the image compression unit 1043 to the development memory 105, whereby the current drawn from the battery 300 can be suppressed. On the other hand, due to the delay in the processing of the data stored in the readout memory 103, there is a possibility that the continuation time of continuous shooting of the image capturing apparatus 100 will be shortened.

Therefore, only when the battery determination unit 110 determines that the state of the battery 300 is a predetermined state (when satisfying a predetermined condition), the front control unit 1021 issues an interrupt notification to the back control unit 1041. The predetermined state is a case where the current supplied from the battery 300 exceeds an allowable value of the battery 300. When the current supplied from the battery 300 exceeds the allowable value, there is a possibility that the voltage of the battery 300 will decrease, output of power from the battery will be stopped by a protection function of the battery 300, and a “system down” of the image capturing apparatus 100 will occur.

In a case where the internal resistance or the wiring resistance of the battery 300 is high, when the maximum current is large, there is a concern that a “system down” will occur also due to the output voltage of the battery falling below the minimum drive voltage of the image capturing apparatus 100.

As a method of determining whether the battery is the predetermined state, first, it is determined by the type of the battery 300. For example, when the DC coupler is inserted, the output voltage is constant unlike the battery 300, and therefore an allowable current of the DC coupler is not exceeded even if operating the image capturing apparatus 100 with high power. Therefore, when the DC coupler is connected, no interrupt notification is issued from the front control unit 1021 to the back control unit 1041.

On the other hand, in a case of determining that the battery 300 of an old type having a low allowable current is inserted or the like, for reduction in the maximum power, the front control unit 1021 issues an interrupt notification to the back control unit 1041 based on the readout timing of the image sensor 101 as described above.

In a case of determining that the battery 300 of a standard type is inserted, the determination is made based on the information obtained from the battery monitoring unit 109. A specific determination method will be described later with reference to FIG. 5.

If not restricting access to the development memory 105 based on the battery information, the front control unit 1021 returns the process to S402 and waits until the next still image readout.

If restricting access to the development memory 105 based on the battery information, the front control unit 1021 issues an interrupt notification to the back control unit 1041 in S405. By this, access restriction to the development memory 105 is given.

In S406, the front control unit 1021 waits for readout of the imaging readout unit 1022 to end.

When the readout of the imaging readout unit 1022 ends, the front control unit 1021 removes the interrupt notification to the back control unit 1041 in S407. By this, the access restriction to the development memory 105 is stopped.

FIG. 5 is a view illustrating a determination example of the battery determination unit 110 with respect to the state of the battery 300 in the present embodiment.

In FIG. 5, a indicates a table for determination by the battery determination unit 110 in the electronic shutter mode. Based on this table, the battery determination unit 110 determines whether or not the front control unit 1021 issues an interrupt notification.

The lower an open circuit voltage of the battery 300 is the higher the concern of the current flowed from the battery 300 exceeding the allowable current of the battery 300 is in a case where the maximum current increases with respect to the maximum power necessary for the image capturing apparatus 100. If the resistance value of the battery 300 is large, the voltage supplied to the system of the image capturing apparatus 100 when a large current flows becomes lower than a predetermined voltage value, and there is an increase in a concern that a “system down” will occur also due to the voltage falling below the minimum drive voltage of the image capturing apparatus 100.

Then, the battery determination unit 110 makes a determination based on the open circuit voltage and the resistance value acquired by the battery monitoring unit 109 and the table of a of FIG. 5.

The horizontal axis indicates the open circuit voltage of the battery 300, and the vertical axis indicates the resistance value of the battery 300. The battery determination unit 110 issues an interrupt notification from the front control unit 1021 to the back control unit 1041 only in the shaded region, and gives access restriction to the development memory 105. Conversely, in another state where the battery 300 has a margin, no interrupt notification is issued from the front control unit 1021 to the back control unit 1041, and no access restriction to the development memory 105 is given.

The voltage of the battery 300 may be determined from the remaining battery capacity, and the resistance value of the battery 300 may be determined from the temperature of the battery 300 and the presence/absence of a battery grip. In a case where the remaining battery capacity is low (the remaining amount falls below a predetermined amount), a battery temperature is lower than a predetermined temperature, the battery grip is mounted, the risk of a “system down” of the image capturing apparatus 100 increases, and thus the front control unit 1021 issues an interrupt notification to the back control unit 1041 and gives access restriction to the development memory 105.

As described above, the battery determination unit 110 determines whether or not to restrict access to the development memory 105 depending on the state of the battery 300. This can suppress a disadvantage that the continuation time of continuous shooting is reduced by restricting access to the development memory 105.

At the time of the mechanical shutter mode as in b of FIG. 5, a table different from that in a of FIG. 5 is used. Other than this, a different table may be used depending on the state of the image capturing apparatus 100, for example, an accessory to be connected or whether or not to be in a wireless connection state. By determining whether or not to restrict access to the development memory 105 depending on the mode and state of the image capturing apparatus 100, it is possible to suppress the disadvantage that the continuation time of continuous shooting is reduced by restricting access to the development memory 105.

Here, the configuration in which the front engine 102 and the back engine 104 are separated has been described in the embodiment, but these functions may be configured as one semiconductor integrated circuit. The present embodiment can also be applied to a configuration including three or more image processing circuits.

As described above, according to the present embodiment, it is possible to reduce an instantaneous current to the battery 300 without adding a component or performing complicated exclusion processing. By giving access restriction to the development memory 105 depending on the state of the battery 300 it is possible to reduce the influence of the image capturing apparatus 100 on the continuation time of continuous shooting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-104353, filed Jun. 27, 2024, which is hereby incorporated by reference herein in its entirety.

What is claimed is:

1. An image capturing apparatus comprising:
an image sensor; and
at least one processor or circuit that executes a program and performs operations of the following units:
a readout unit that reads out image data from the image sensor,
a processing unit that performs a processing for recording on image data read out by the readout unit,
a memory that is accessed by the processing unit for processing of the image data, and
a control unit that performs a control to restrict access of the processing unit to the memory during a readout period of image data by the readout unit in a shooting mode in which the readout unit reads out image data of a still image for recording from the image sensor and the processing unit performs the processing for the record.

2. The image capturing apparatus according to claim 1, wherein in a case where a state of a battery that supplies power for the image capturing apparatus satisfies a predetermined condition, the control unit restricts the access of the processing unit to the memory during the readout period of the image data of the still image for recording by the readout unit.

3. The image capturing apparatus according to claim 2, wherein the at least one processor or circuit further performs operations of
a monitoring unit that monitors the state of the battery,
wherein the control unit determines whether or not the state of the battery satisfies the predetermined condition based on information regarding the state of the battery from the monitoring unit.

4. The image capturing apparatus according to claim 2, wherein the predetermined condition is at least any of a remaining amount of the battery being less than a predetermined amount, an output voltage of the battery being lower than a predetermined voltage value, a resistance value of the battery being higher than a predetermined resistance value, and a temperature of the battery being lower than a predetermined temperature.

5. The image capturing apparatus according to claim 1 comprising:
a first image processing circuit including the readout unit and the control unit and configured as one semiconductor integrated circuit chip; and
a second image processing circuit including the processing unit and configured as one semiconductor integrated circuit chip different from the first image processing circuit, wherein
the readout unit transmits the image data read out from the image sensor to the second image processing circuit,
the processing unit processes the image data sent from the first image processing circuit, and
the memory is a memory for the second image processing circuit.

6. The image capturing apparatus according to claim 5 comprising:
a second memory for the first image processing circuit, wherein the at least one processor or circuit further performs operations of a second control unit included in the second image processing circuit,
the readout unit stores, in the second memory, the image data read out from the image sensor, and then reads the image data from the second memory, and sends the image data read out from the second memory to the second image processing circuit,
before a start of readout of image data of one picture from the image sensor, the control unit notifies the second control unit of a request for the restriction of access to the memory, and upon completing a storage of the image data of one picture into the second memory, notifies the second control unit of stop of the restriction of the access, and
the second control unit performs control of restricting the access in response to a notification of the request for restriction of the access, and performs control of stop the restriction of the access in response to a notification of stop of restriction of the access.

7. The image capturing apparatus according to claim 1, wherein the processing unit includes a correction unit that corrects the image data, and a compression unit that compresses image data corrected by the correction unit.

8. The image capturing apparatus according to claim 1, wherein in a continuous shooting mode in which the readout unit continuously reads out image data of a plurality of still images and the processing unit performs processing for the record on image data of the plurality of still images, the control unit restricts access of the processing unit to the memory during the readout period of image data of the plurality of still images by the readout unit.

9. The image capturing apparatus according to claim 1 further comprising a mechanical shutter that controls exposure of the image sensor, wherein the control unit restricts the access of the processing unit to the memory during an operation of the mechanical shutter.

10. The image capturing apparatus according to claim 1, wherein the at least one processor or circuit further performs operations of
a recording unit that records image data processed by the processing unit, and the control unit further restricts the access of the processing unit to the recording unit during a readout period of image data by the readout unit.

11. A method for controlling an image capturing apparatus including an image sensor, a first processing circuit that receives image data read out from the image sensor, a second processing circuit that inputs image data output from the first processing circuit and performs processing for record, and a memory for the second processing circuit, the method comprising:
restricting access to the memory in the processing during a readout period of image data by the readout in a shooting mode in which the first processing circuit reads out image data of a still image for record from the image sensor and the second processing circuit performs processing for the record.

12. An image capturing apparatus comprising:
an image sensor;
a first integrated circuit (IC) chip;
a first memory;
a second IC chip;
a second memory,
wherein the first IC chip has a first controller that performs a control, in a shooting mode in which the first IC chip reads out image data of a still image for recording from the image sensor and the second IC chip performs a processing for recording on image data, to read out the image data of the still image for recording from the image sensor, store the image data in the first memory, read out the image data from the first memory, and send the image data read out from the first memory to the second IC chip,
the second IC chip has a second controller that performs a control in the shooting mode to receive the image data from the first IC chip, perform the processing for recording on the image data received from the first IC chip with an access to the second memory, and record the processed image data on a recording medium, and
wherein the first controller performs a control to restrict the access to the second memory for the processing for recording on the image data by the second IC chip during a readout period of image data by the first IC chip in the shooting mode.

13. The image capturing apparatus according to claim 12, wherein the first controller issues a restricting instruction to the second IC chip and the second controller restricts the access to the second memory for the processing for recording on the image data in accordance with the restricting instruction, and
wherein the first controller issues a remove instruction to the second IC chip and the second controller stop restricting the access to the second memory for the processing for recording on the image data in accordance with the remove instruction.

14. The image capturing apparatus according to claim 13, wherein the first controller issues the restriction instruction to the second IC chip before a start of reading out the image data of one picture from the image sensor and issues the remove instruction to the second IC chip in accordance with a completion of storing the image data of one picture read out from the image sensor in the first memory.

15. The image capturing apparatus according to claim 12, further comprising:
a power controller that receives power from a battery and performs a control to supply power to the image capture apparatus,
wherein the first controller controls the power controller to restrict power supplied to the second IC chip in an image capturing standby mode in which the first IC chip reads out image data for live view image from the image sensor, develops the image data for live view image, and displays the live view image of the developed image data on a display and the second IC chip stops the processing for recording on image data,
wherein the access to the second memory for the processing for recording on image data is stopped in the second IC chip in the image capturing standby mode.

16. The image capturing apparatus according to claim 15, wherein the first controller controls the power controller to stop a restriction of power supplied to the second IC chip in accordance with a shooting preparation instruction by a user in the image capturing standby mode and changes the image capturing apparatus to the shooting mode in accordance with a shooting instruction by the user.
